(19) United States
(12) Patent Application Publication
(10) Pub. No.: US 2025/0329201 A1
(43) Pub. Date: Oct. 23, 2025

(54) CHANGING THE COMMUNICATION MODE OF AN ACCESS CONTROL PROTOCOL

(71) Applicant: ASSA ABLOY AB, Stockholm (SE)

(72) Inventor: Martin Kaufmann, Graz (AT)

(21) Appl. No.: 18/869,526

(22) PCT Filed: Sep. 15, 2022
(86) PCT No.: PCT/EP2022/075654

§ 371 Date: Nov. 26, 2024

Related U.S. Application Data
(60) Provisional application No. 63/366,649, filed on Jun. 20, 2022.

(51) Int. Cl. G07C 9/00

(52) U.S. Cl. CPC G07C 9/00174; G07C 2009/00396

(57) ABSTRACT

A method of operating an access control system includes sending, by an access reader of the access control system, a message to a user device to activate an access application or access applet of the user device, wherein the access reader is an Initiator device and the user device is a Responder device for a communication transaction; authenticating the user device; sending, by the access reader, a command to change the user device to the Initiator device for the communication transaction and the access reader to the Responder device; initiating, by the user device, an action of the access control system including sending a message to the access reader; and performing, by the access reader, at least a portion of the action in response to the message sent by the user device.

### PRIORITY APPLICATION

This application claims priority to U.S. Provisional Patent Application Ser. No. 63/366,649, filed Jun. 20, 2022, the disclosure of which is incorporated herein in its entirety by reference.

### TECHNICAL FIELD

Embodiments illustrated and described herein generally relate to automatic identity authentication systems that authenticate users for access to secure resources.

### BACKGROUND

Physical access control systems (PACs) grant physical access to an authorized user through a controlled portal. The PACs include one or more access devices and user devices located with users wishing to get access authorization. The access device acts as a master device to control flow of communication with the user device. However, this limits the functionality between the two devices.

### BRIEF DESCRIPTION OF THE DRAWINGS

FIG. 1 is an illustration of an example of portions of a physical access control system.

FIG. 2 is an example communication transaction between devices of a physical access control system.

FIG. 3 is a block diagram schematic of portions of an example of a device of a physical access control system.

### DETAILED DESCRIPTION

A Physical Access Control System (PACS) is a type of system that authenticates and authorizes a person to pass through a physical access point such as a secured door. The architecture of a PACS may vary based on the application (e.g., a hotel, a residence, an office, etc.), the technology (e.g., access interfaces technology, door type, etc.), and the manufacturer.

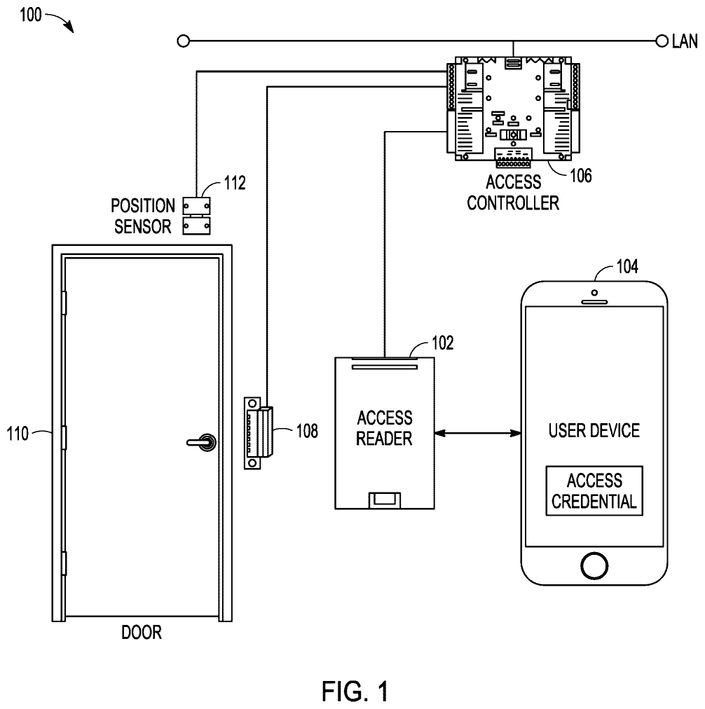

FIG. 1 is an example of portions of a PACS. The system 100 includes an access reader device or access reader 102, an access controller 106, and a user device 104. The user device 104 stores an access credential. The access credential is a data object that provides proof of the user's identity. The user device 104 can be a smartphone as shown, or any mobile device such as a wearable computing device (e.g., a smartwatch), a tablet computer, or other portable computing device configurable to emulate a virtual credential. The access reader 102 retrieves and authenticates the access credential. The access controller 106 may compare the access credential to an access control list to grant or deny access to the controlled area, such as by controlling an automatic lock 108 on a door 110 for example. The automatic lock 108 may be an electronic, mechanical, or magnetic locking device or a combination thereof. The functionality of the access controller 106 may be included in the access reader 102, and the combined reader/control device can be referred to as an offline reader or standalone reader. If the unlocking mechanism is included as well, the access reader 102 can be a smart door lock. The PACS may include a position sensor 112 to detect presence of someone wishing to gain entry to the controlled area.

Authentication messaging may be used to verify that the access credential provides the desired access. If the user device 104 is a smartphone, the messaging may use out of band (OOB) signaling (e.g., Bluetooth® Low Energy signaling) different from the cellular network used by the smartphone. The authentication messaging follows a communication protocol, and the messaging can be made secure, e.g., using one or more session keys to encrypt the messages of a communication session between the access reader 102 and the user device 104.

Typically, for most communication protocols (e.g., wired, wireless) between two devices, one device is the Initiator (or master device) and the other device is the Responder (or subordinate device) that can only respond to the messaging of the Initiator, and these roles stay the same until the end of the communication transaction. This can limit the functionality that can be included in the user device 104. It would be desirable for the communication protocol between the access reader 102 and the user device 104 to allow change of roles of the devices between Initiator and Responder during a communication transaction. The change would allow the passive Responder to become the active Initiator to increase the functions that can be performed by the user device 104.

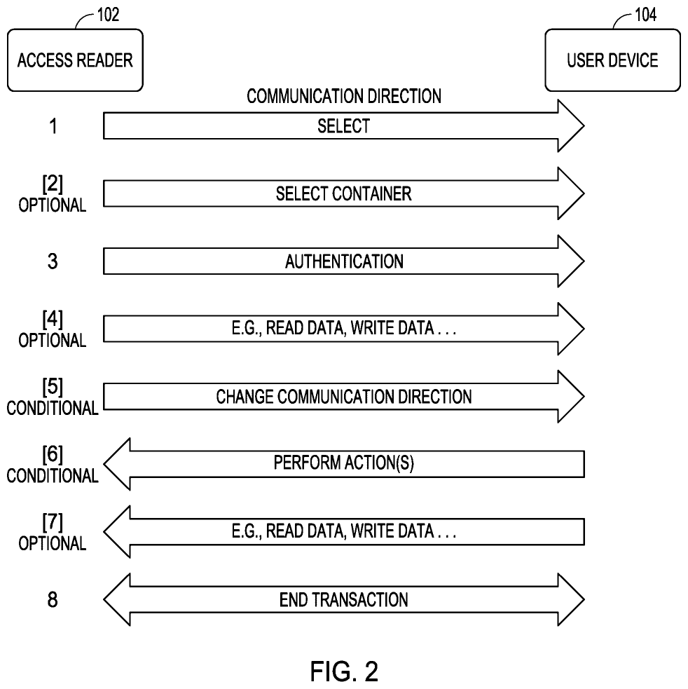

FIG. 2 shows an example communication transaction where roles of the devices change, and the communication direction changes between the access reader 102 and the user device 104. The access reader 102 starts the communication with the user device 104. The communication direction is reflected in the arrows in FIG. 2, The arrows show the communication from the Initiator to the Responder. If the communication includes command-response pairs, some of the response messages of the pairs may not be shown in FIG. 2 and not reflected by the arrows.

In FIG. 2, the steps (1-8) of the example communication transaction are listed on the left. In step 1, the access reader 102 selects or activates the application or applet in the user device 104 that communicates with the access reader 102. This selection may be in response to the access reader 102 detecting a beacon emitted by the user device 104. The beacon may be a low energy level beacon signal in a low energy broadcast mode. For example, the user device 104 may support background Bluetooth Low Energy advertising. Bluetooth Low Energy is only an example and other wireless protocols either long range or short range can be used. The term beacon is intended to include all wireless signals that can potentially serve the functions of the beacon described herein. In some examples, the access reader 102 initiates selecting the application or applet in the user device 104 in response to a signal from the position sensor 112 when presence of an end-user is detected.

In optional step 2, the access reader 102 selects the data container of the user device 104 in which the access credential data is stored. Depending on the structure of the application or applet, it may be required to select a data container (e.g., an isolated or secured data container) within the application or applet. This allows the PACS to manage access credential data in an isolated data container specifically for this access reader 102. This is useful when the application or applet installed in the user device 104 can be used with multiple access control systems.

Step 3 is a device authentication step in which mutual authentication is performed by the devices. The access credential data is exchanged as part of the authentication. For example, the access reader 102 may read the access credential data from the isolated data container of the user device 104.

In optional step 4, the communication between the access reader 102 and the user device 104 can be extended to include the access reader 102 initiating additional transfer of data with the user device 104. For example, the access reader 102 may read system specific information stored in the user device 104 and may write system specific data to the user device 104. For example, in step 4 the access reader 102 may retrieve a user log stored in the user device 104, or update a revocation list stored in the user device 104.

In steps 1-4, the access reader 102 has the role of the Initiator of the communications and the user device 104 has the role of the Responder to messages from the Initiator. In step 5, the roles of the devices are reversed, and the communication direction is changed. Step 5 may be conditional on the access reader 102 sending a “manage channel command” to the user device 104 to change the communication direction and the user device 104 sending a response message to the command (e.g., an acknowledge (ACK) message, or other status message). The OOB signaling supports either device being the Initiator. A manage channel command may be sent by an Initiator using secure messaging and may be protected by encryption.

When the access reader 102 receives the response message from the user device 104, the access reader 102 relinquishes its role as Initiator to the user device 104. There are use-cases where it is useful for the user device 104 to be the Initiator. For example, the communication session in FIG. 2 may be used to interactively reconfigure the access reader 102. The user device 104 may initiate a transfer reconfiguration information such as firmware to the access reader 102 as part of the configuring of the access reader 102. Other interaction of the user device 104 with the access reader 102 may include the user device 104 needing to be the Initiator of an exchange of data with the access reader 102.

In conditional step 6, one or more actions are initiated by the user device 104 and performed using one or both of the access reader 102 and the user device 104. The access reader 102 is subordinate to the user device 104. Step 6 is conditional because the change in communication direction of step 5 needs to be performed before actions can be taken by the user device 104. The action performed can be one or more non-default actions. In one use-case example, the end-user interacts with the door 110 in FIG. 1 (e.g., to lock or unlock the door, get the status of the door, etc.) during the communication session. The actions are initiated by the user device 104 and the access reader 102 responds to commands or messages to perform at least a portion of the action.

Optional step 7 is similar to optional step 4, except that the user device 104 is the Initiator of the transfer of the additional data. The reading of data is in a direction opposite to that in step 4, and direction of write data is in the opposite direction from step 4.

Step 8 ends the communication transaction. A command message may be sent to end the transaction. The message is sent from the current Initiator device. The end transaction message or command may be sent from the user device 104 if step 5 was performed and the user device 104 is the Initiator. The end transaction message may be used to update the user interface of the user device to indicate the communication transaction is over. It may be desirable to end the communication transaction as quickly as possible for security reasons. Otherwise, the communication channel remains open, and the access control system may be vulnerable to attack. This is especially true for longer distance hardware protocols or if the communication between devices involves an area network.

The roles of the devices can be changed back during the same communication transaction. The manage channel command may be sent by the user device 104 to change the role of the access reader 102 back to the Initiator. The access reader 102 sends a command response message back to the user device 104 to complete the change. More actions may be initiated by the access reader 102 after the device roles are changed back. In some examples, the end transaction command closes the communication channel (e.g., a secure communication channel) and the next communication begins with the access reader having the role of the Initiator device.

Table 1 is an example of a “Manage Channel Command.” The command may only be executed with active secure messaging. The class (CLA) byte may be a proprietary value so that the command is not captured on an operating system (OS) level and instead reaches the application or applet running on the user device 104. The command data field [Text1] is optional and command data can be omitted. If no command data is included, the length of data (Lc) field may be omitted.

TABLE 1

| FIELD | VALUE DESCRIPTION |
|---|---|
| CLA | ‘80’ |
| INS | ‘70’ |
| P1 | ‘10’ . . . continue logical channel in reverse direction |
| P2 | ‘00’ |
| Lc | Length of Data field |
| Data | [Text1] |
| Le | ‘00’ |

Table 2 is an example of a “Manage Channel Command Response.” The response data field [Text2] is optional and response data can be omitted. The communication direction is changed, and the role of Initiator and Responder reversed after successful receipt of the Manage Channel Command Response.

TABLE 2

| FIELD | VALUE DESCRIPTION |
|---|---|
| Data | [Text2] |
| SW1SW2 | Status Code |

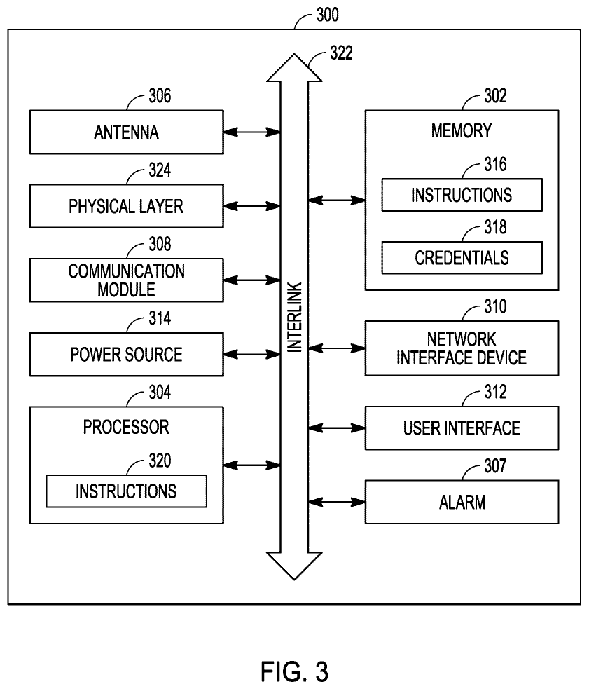

FIG. 3 is a block diagram schematic of various example components of a device 300 for supporting the device architectures described and illustrated herein. The device 300 of FIG. 3 could be, for example, an access reader device (e.g., the access reader 102 of FIGS. 1 and 2) that authenticates credential information of authority, status, rights, and/or entitlement to privileges for the holder of the device. The device 300 initiates authentication of access rights of a user device during a communication transaction and changes the direction of communication during the communication transaction and the designated initiator of communication during the communication transaction.

With reference specifically to FIG. 3, additional examples of a device 300 for supporting the device architecture described and illustrated herein may generally include one or more of a memory 302, processing circuitry such as processor 304, one or more antennas 306, a communication port or communication module 308, a network interface device 310, a user interface 312, and a power source 314 or power supply.

Memory 302 can be used in connection with the execution of application programming or instructions by processing circuitry, and for the temporary or long-term storage of program instructions or instruction sets 316 and/or authorization data 318, such as credential data, credential authorization data, or access control data or instructions, as well as any data, data structures, and/or computer-executable instructions needed or desired to support the above-described device architecture. For example, memory 302 can contain executable instructions 316 that are used by a processor 304 of the processing circuitry to run other components of device 300, to calculate encryption keys to communicate credential or authorization data 318, and/or to perform any of the functions or operations described herein, such as the functions as operations of an access reader device described regarding the communication transaction of FIG. 2 for example.

Memory 302 can comprise a computer readable medium that can be any medium that can contain, store, communicate, or transport data, program code, or instructions for use by or in connection with device 300, such as instructions for a verification application for example. Memory can include memory contained in a secure element of the mobile device. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

The processing circuitry of the device 300 is configured (e.g., by firmware) to perform the functions of the access reader described herein. Such as the functions and operations of the access reader described regarding the communication transaction of FIG. 2 for example. The processing circuitry can correspond to one or more computer processing devices or resources. For instance, processor 304 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 304 can be provided as a microprocessor, Central Processing Unit (CPU), or plurality of microprocessors or CPUs that are configured to execute instructions sets stored in an internal memory 320 and/or memory 302. Processing circuitry can include a processor in a secure element of the mobile device.

Antenna 306 can correspond to one or multiple antennas and can be configured to provide for wireless communications between device 300 and another device. Antenna(s) 306 can be operatively coupled to physical layer circuitry comprising one or more physical (PHY) layers 324 to operate using one or more wireless communication protocols and operating frequencies including, but not limited to, the IEEE 802.15.1, Bluetooth, Bluetooth Low Energy, near field communications (NFC), ZigBee, GSM, CDMA, Wi-Fi, RF, ultra-wide band (UWB), and the like. In an example, antenna 306 may include one or more antennas coupled to one or more physical layers 324 to operate using UWB for in band activity/communication and Bluetooth for out-of-band (OOB) activity/communication. However, any RFID or personal area network (PAN) technologies, such as the IEEE 502.15.1, near field communications (NFC), ZigBee, GSM, CDMA, Wi-Fi, etc., may alternatively or additionally be used for the OOB activity/communication described herein.

Device 300 may additionally include a communication module 308 and/or network interface device 310. Communication module 308 can be configured to communicate according to any suitable communications protocol with one or more different systems or devices either remote or local to device 300. Network interface device 310 includes hardware to facilitate communications with other devices over a communication network utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device 310 can include an Ethernet port or other physical jack, a Wi-Fi card, a Network Interface Card (NIC), a cellular interface (e.g., antenna, filters, and associated circuitry), or the like. In some examples, network interface device 310 can include a plurality of antennas to wirelessly communicate using at least one of single-input multiple-output (SIMO), multiple-input multiple-output (MIMO), or multiple-input single-output (MISO) techniques. In some example embodiments, one or more of the antenna 306, communication module 308, and/or network interface device 310 or subcomponents thereof, may be integrated as a single module or device, function or operate as if they were a single module or device, or may comprise of elements that are shared between them.

User interface 312 can include one or more input devices and/or display devices. Examples of suitable user input devices that can be included in user interface 312 include, without limitation, one or more buttons, a keyboard, a mouse, a touch-sensitive surface, a stylus, a camera, a microphone, etc. Examples of suitable user output devices that can be included in user interface 312 include, without limitation, one or more LEDs, an LCD panel, a display screen, a touchscreen, one or more lights, a speaker, etc. It should be appreciated that user interface 312 can also include a combined user input and user output device, such as a touch-sensitive display or the like. The user interface 312 may include a separate alarm circuit 307 to indicate an alarm condition such as a security breach. Alarm circuit 307 may provide an audio signal to a speaker or may activate a light or present an alarm condition using a display device.

Power source 314 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the device 300. Device 300 can also include one or more interlinks or buses 322 operable to transmit communications between the various hardware components of the device. A system bus 322 can be any of several types of commercially available bus structures or bus architectures.

### ADDITIONAL DISCLOSURE AND EXAMPLES

Example 1 includes subject matter (such as a method of operating an access control system) comprising sending, by an access reader of the access control system, a message to a user device to activate an access application or access applet of the user device. The access reader is an Initiator device and the user device is a Responder device for a communication transaction. The subject matter further comprising authenticating the user device; sending, by the access reader, a command to change the user device to the Initiator device for the communication transaction and change the access reader to the Responder device; initiating, by the user device, an action of the access control system, including sending a message to the access reader; and performing, by the access reader, at least a portion of the action in response to the message sent by the user device.

In Example 2, the subject matter of Example 1 optionally includes sending, by the user device, a command response message to the access reader; and the access reader changing to the Responder device in response to receiving the command response message.

In Example 3, the subject matter of one or both of Examples 1 and 2 optionally includes sending, by the user device, another command to change the access reader back to the Initiator device for the communication transaction and change the user device back to the Responder device; and initiating, by the access reader, an action of the access control system.

In Example 4, the subject matter of Example 3 optionally includes the user device sending an end transaction command to close the communication transaction, and the access reader changing back to the Initiator device in response to the end transaction command.

In Example 5, the subject matter of one or any combination of Examples 1-4 optionally includes the user device sending an end transaction command; the access reader device closing a secure communication channel in response to receiving the end transaction command; and the access reader device initiating a subsequent communication transaction.

In Example 6, the subject matter of one or any combination of Examples 1-5 optionally includes the action of the access control system initiated by the user device including the user device reconfiguring the access reader.

In Example 7, the subject matter of one or any combination of Examples 1-6 optionally includes the action of the access control system initiated by the user device including the user device transferring firmware to the access reader.

In Example 8, the subject matter of one or any combination of Examples 1-7 optionally includes the action of the access control system initiated by the user device including the user device controlling access to a physical access portal controlled by the access reader.

Example 9 includes subject matter, such as an access reader of an access control system, or can optionally be combined with one or any combination of Examples 1-8 to include such subject matter, comprising physical layer circuitry layer configured to communicate wirelessly with a separate user device; at least one hardware processor operatively coupled to the physical layer circuitry; a memory a memory storing instructions that cause the at least one hardware processor to perform operations including: initiating a communication transaction with the separate user device, the communication transaction including sending a message to the separate user device to activate an access application or access applet of the user device, wherein the access reader is an Initiator device and the user device is a Responder device for the communication transaction; authenticating the user device; sending a command to cause the user device to change to the Initiator device of the communication transaction; changing to the Responder device of the communication transaction and waiting for a command from the user device; and performing an action of the access control system in response to a command received from the user device.

In Example 10, the subject matter of Example 9 optionally includes the memory storing instructions that cause the at least one hardware processor to perform operations including changing the access reader to the Responder device in response to a command response message received from the user device.

In Example 11, the subject matter of one or both of Examples 9 and 10 optionally includes the memory storing instructions that cause the at least one hardware processor to perform operations including: receiving a command from the user device to change back to the Initiator device of the communication transaction; and initiating a subsequent action of the access control system as the Initiator device of the communication transaction.

In Example 12, the subject matter of one or any combination of Examples 9-11 optionally includes the memory storing instructions that cause the at least one hardware processor to perform operations including: receiving an end transaction command from the user device; and closing the communication transaction and changing back to the Initiator device in response to the end transaction command.

In Example 13, the subject matter of one or any combination of Examples 9-12 optionally includes the memory storing instructions that cause the at least one hardware processor to perform operations including: establishing a secure communication channel for the communication transaction; receiving an end transaction command from the user device; and closing the secure communication channel and changing back to the Initiator device in response to the end transaction command.

In Example 14, the subject matter of one or any combination of Examples 9-13 optionally includes the memory storing instructions that cause the at least one hardware processor to perform operations including reconfiguring the access reader using reconfiguration information received from the user device.

In Example 15, the subject matter of one or any combination of Examples 9-14 optionally includes the memory storing instructions that cause the at least one hardware processor to perform operations including receiving a command from the user device to manage access to a physical access portal controlled by the access reader.

Example 16 includes a computer readable storage medium including instructions that when executed by at least one processor of a user device, causes the user device to perform operations comprising receiving a message as part of a communication transaction with a separate device of an access control system to activate an access application or access applet of the user device, wherein the separate device is an Initiator device of the communication transaction; performing instructions of the access application or access applet in response to the message, including sending an authentication credential to the Initiator device; receiving a command to change to the Initiator device of the communication transaction; and initiating the sending of a command to the separate device to cause the separate device to perform at least a portion of an action of the access control system.

In Example 17, the subject matter of Example 16 includes instructions that cause the user device to perform operations including sending another command to cause the separate device to change back to the Initiator device of the communication transaction; and changing back to the Responder device and waiting for a command from the separate device.

In Example 18, the subject matter of one or both of Examples 16 and 17 optionally includes instructions that cause the user device to perform operations including initiating the sending of reconfiguration information to the separate device.

In Example 19, the subject matter of one or any combination of Examples 16-18 optionally includes instructions that cause the user device to perform operations including initiating the transfer of firmware to the separate device.

In Example 20, the subject matter of one or any combination of Examples 16-19 optionally includes instructions that cause the user device to perform operations including initiating the sending of a command to the separate device to control access to a physical access portal controlled by the separate device.

These non-limiting Examples can be combined in any permutation or combination. The above detailed description includes references to the accompanying drawings, which form a part of the detailed description. The drawings show, by way of illustration, specific embodiments in which the invention can be practiced. The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, the subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A method of operating an access control system, the method comprising:
sending, by an access reader of the access control system, a message to a user device to activate an access application or access applet of the user device, wherein the access reader is an Initiator device and the user device is a Responder device for a communication transaction;
authenticating the user device;
sending, by the access reader, a command to change the user device to the Initiator device for the communication transaction and change the access reader to the Responder device;
initiating, by the user device, an action of the access control system, including sending a message to the access reader; and
performing, by the access reader, at least a portion of the action in response to the message sent by the user device.

2. The method of claim 1, including:
sending, by the user device, a command response message to the access reader; and
the access reader changing to the Responder device in response to receiving the command response message.

3. The method of claim 1, including:
sending, by the user device, another command to change the access reader back to the Initiator device for the communication transaction and change the user device back to the Responder device; and
initiating, by the access reader, an action of the access control system.

4. The method of claim 3, wherein sending the other command includes the user device sending an end transaction command to close the communication transaction, and the access reader changing back to the Initiator device in response to the end transaction command.

5. The method of claim 1, including:
the user device sending an end transaction command;
the access reader device closing a secure communication channel in response to receiving the end transaction command; and
the access reader device initiating a subsequent communication transaction.

6. The method of claim 1, wherein the action of the access control system initiated by the user device includes the user device reconfiguring the access reader.

7. The method of claim 1, wherein the action of the access control system initiated by the user device includes the user device transferring firmware to the access reader.

8. The method of claim 1, wherein the action of the access control system initiated by the user device includes the user device controlling access to a physical access portal controlled by the access reader.

9. An access reader of an access control system, the access reader comprising:
physical layer circuitry layer configured to communicate wirelessly with a separate user device;
at least one hardware processor operatively coupled to the physical layer circuitry;
a memory a memory storing instructions that cause the at least one hardware processor to perform operations including:
initiating a communication transaction with the separate user device, the communication transaction including sending a message to the separate user device to activate an access application or access applet of the user device, wherein the access reader is an Initiator device and the user device is a Responder device for the communication transaction;
authenticating the user device;
sending a command to cause the user device to change to the Initiator device of the communication transaction;
changing to the Responder device of the communication transaction and waiting for a command from the user device; and
performing an action of the access control system in response to a command received from the user device.

10. The access reader of claim 9, wherein the memory stores instructions that cause the at least one hardware processor to perform operations including changing the access reader to the Responder device in response to a command response message received from the user device.

11. The access reader of claim 9, wherein the memory stores instructions that cause the at least one hardware processor to perform operations including:
receiving a command from the user device to change back to the Initiator device of the communication transaction; and
initiating a subsequent action of the access control system as the Initiator device of the communication transaction.

12. The access reader of claim 9, wherein the memory stores instructions that cause the at least one hardware processor to perform operations including:
receiving an end transaction command from the user device; and
closing the communication transaction and changing back to the Initiator device in response to the end transaction command.

13. The access reader of claim 9, wherein the memory stores instructions that cause the at least one hardware processor to perform operations including:
establishing a secure communication channel for the communication transaction;
receiving an end transaction command from the user device; and
closing the secure communication channel and changing back to the Initiator device in response to the end transaction command.

14. The access reader of claim 9, wherein the memory stores instructions that cause the at least one hardware processor to perform operations including reconfiguring the access reader using reconfiguration information received from the user device.

15. The access reader of claim 9, wherein the memory stores instructions that cause the at least one hardware processor to perform operations including receiving a command from the user device to manage access to a physical access portal controlled by the access reader.

16. A non-transitory computer readable storage medium including instructions that when executed by at least one processor of a user device, causes the user device to perform operations comprising:
receiving a message as part of a communication transaction with a separate device of an access control system to activate an access application or access applet of the user device, wherein the separate device is an Initiator device of the communication transaction;
performing instructions of the access application or access applet in response to the message, including sending an authentication credential to the Initiator device; and
receiving a command to change to the Initiator device of the communication transaction; and
initiating a sending of a command to the separate device to cause the separate device to perform at least a portion of an action of the access control system.

17. The non-transitory computer readable storage medium of claim 16, including instructions that cause the user device to perform operations including:
sending another command to cause the separate device to change back to the Initiator device of the communication transaction; and
changing back to the Responder device and waiting for a command from the separate device.

18. The non-transitory computer readable storage medium of claim 16, including instructions that cause the user device to perform operations including initiating sending of reconfiguration information to the separate device.

19. The non-transitory computer readable storage medium of claim 16, including instructions that cause the user device to perform operations including initiating the transfer of firmware to the separate device.

20. The non-transitory computer readable storage medium of claim 16, including instructions that cause the user device to perform operations including initiating sending a command to the separate device to control access to a physical access portal controlled by the separate device.
